(19) United States
(12) Patent Application Publication
(10) Pub. No.: US 2025/0232360 A1
(43) Pub. Date: Jul. 17, 2025

(54) SYSTEM AND METHOD FOR SMART SHOPPING IN A RETAIL ENVIRONMENT

(71) Applicant: RETAILETICS SDN BHD, Petaling Jaya (MY)

(72) Inventors: Sadhanand Shaji K.RAJAPPAN, Shah Alam (MY); Manirajah KULANTHAVELU, Putrajaya (MY)

(73) Assignee: RETAILETICS SDN BHD, Petaling Jaya (MY)

(21) Appl. No.: 18/961,149

(22) Filed: Nov. 26, 2024

Related U.S. Application Data
(63) Continuation-in-part of application No. 17/615,042, filed on Nov. 29, 2021, now Pat. No. 12,182,850.

(30) Foreign Application Priority Data
May 28, 2019 (MY) PI 2019003022

(51) Int. Cl. G06Q 30/0601; G01G 19/08; G01G 19/414; G06Q 20/20; G06Q 20/40; G06V 10/44; G06V 10/74; G06V 20/52; H02J 50/00

(52) U.S. Cl. CPC G06Q 30/0633; G01G 19/08; G01G 19/4144; G06Q 20/208; G06Q 20/407; G06Q 30/0641; G06V 10/44; G06V 10/761; G06V 20/52; H02J 50/00

(57) ABSTRACT

The present invention relates to a system (100) and method (300) for automated product validation, identification, and transaction management in shopping environments. The system (100) integrates a smart shopping cart (102) equipped with at least one camera (106), a load cell (108), and a user interface (110). An AI model trained on a dataset of high-resolution, 360° product images generate unique image embeddings for each product. The system performs multimodal validation by comparing the extracted image embeddings, measured weight data, and scanned barcode information with reference data stored in a vector database. Further, discrepancies, such as unscanned products or mismatches, are flagged, and payment is blocked until resolved.

### CROSS-REFERENCE TO RELATED APPLICATION

The present patent application is a continuation application of prior U.S. non provisional patent application Ser. No. 17/615,042, titled “Shopping system and method” and filed on May 22, 2020, which is incorporated herein by reference.

### FIELD OF THE INVENTION

The present invention relates to system and method for smart shopping in a retail environment. In particular, the present invention provides a system and method for smart shopping that utilizes a processing unit integrated with a smart shopping cart, for analysing data derived from product images, scanned barcodes, and load cells for detecting any scanned or unscanned product added into the cart and to validate the weight of the product with the weight data in the system.

that a product has been placed inside the smart shopping cart.

### BACKGROUND

The rapid rise of online retail has created significant challenges for brick-and-mortar retailers, altering the competitive landscape of the retail industry. Online stores leverage direct sourcing from manufacturers and distributors, offering consumers advantages such as greater product variety, lower prices, delivery services, 24/7 availability, and real-time engagement through live chat, social media, and mobile applications. Moreover, online platforms have access to detailed insights into visitors' pre-shopping activities, enabling them to craft personalized shopping experiences, targeted landing pages, and adaptive sales strategies, engaging customers from the moment they access the platform.

In contrast, brick-and-mortar retailers face numerous disadvantages. While online stores thrive on personalization and convenience, physical stores struggle to replicate these experiences. Customers visiting offline retailers are often overwhelmed by a lack of choices compared to online stores and dissatisfied with the absence of personalized interactions. Additionally, brick-and-mortar retailers lack access to consumer wish lists and other critical data, resulting in the retailer being unable to engage shoppers inside their store(s) or personalise their shopping experience.

Further exacerbating these challenges, physical retailers lack real-time insights into customer behavior. Unlike their online counterparts, they cannot determine who is in their stores, what customers are seeking, which brands or products they are comparing, or their likelihood of returning after enduring lengthy checkout processes. Offline retailers primarily rely on consolidated historical sales data, typically analyzed weeks later, which limits their ability to respond dynamically to changing consumer demands. This inability to predict demand accurately often results in overstocking, understocking, lost revenue opportunities, and inventory wastage, as highlighted in reports by leading analysts such as Forbes and Forrester.

Moreover, conventional technologies suffer from inadvertently or deliberate unscanned items at the cashier or traditional self-checkout kiosks that results in billions of dollars in losses annually. This impacts a retailer's revenue and creates challenges in maintaining a secure shopping environment. To mitigate this, retailers resort to hiring security personnel to check shoppers bags and receipts after they have paid and are exiting the store. These methods can be intrusive, detracting from the customer experience, and fail to integrate seamlessly into the operational workflow of a retail store. These challenges leave many consumers, particularly millennials in Southeast Asia and other regions, dissatisfied with the shopping experience in brick-and-mortar stores. The lack of personalization, inadequate in-store services, limited choice, and inefficient systems for managing both customer expectations and inventory highlight the pressing need for innovation in offline retail.

In addition, conventional offline stores or brick-and-mortar retailers face significant challenges, including labor shortages and high operational costs within the retail industry. These challenges make it exceedingly difficult to address issues such as scanning or payment errors effectively. Consequently, there is an increasing demand for a smart system and method that not only resolves operational inefficiencies and the lack of personalization in brick-and-mortar stores but also integrates advanced mechanisms to improve both retailer profitability and the overall customer experience.

In light of the above, there exists a need to provide an improved shopping system and method, that at least overcomes the aforementioned drawbacks.

### SUMMARY

The present invention relates to system and method for smart shopping in a retail environment. In particular, the present invention provides a system and method for smart shopping that utilizes a processing unit integrated with a smart shopping cart, for analysing data derived from product images, scanned barcodes, and associated weight measurements, for detecting any unscanned product placed inside the smart shopping cart.

One aspect of the present invention provides a system (100) for smart shopping in a retail environment. The system (100) comprises a smart shopping cart (102) for collecting at least one product therein; a barcode scanner (104), for enabling a customer to scan barcode of the at least one product, before placing inside the smart shopping cart (102); at least one camera (106), positioned at predefined positions of the smart shopping cart (102), for capturing images of interior thereof. The at least one camera (106) is configured to capture a background image of the interior of the smart shopping cart (102) before a new product is placed, and capture a foreground image of the interior of the smart shopping cart (102) after the new product is placed. The system (100) further discloses at least one load cell (108), integrated within the smart shopping cart (102), and configured to measure weight of the at least one product added to the smart shopping cart (102). Further, a user interface (110) is disclosed that is integrated with the smart shopping cart (102) for displaying a list of products added to the smart shopping cart (102) in real-time. Furthermore, the system (100) discloses a database arrangement (112) comprising a vector database, for storing a plurality of reference embeddings related to the at least one product; and a processing unit (114), communicably coupled to the database arrangement (110), the barcode scanner (104), the at least one camera (106), and the load cell (108). The processing unit (114) is configured to receive scanned barcode data from the barcode scanner (104); process the background image and the foreground image captured by the at least one camera to identify and isolate the new product; extract image embeddings of the new product using an Artificial Intelligence, AI model trained on reference product images; query the vector database using extracted image embedding, to perform a multimodal similarity search, thereby retrieving matching reference embeddings and reference data associated therewith; compare the extracted image embeddings of the new product and the scanned barcode against the retrieved reference embeddings; tag the new product to be valid when the extracted image embeddings and data related to the scanned bar code matches with the retrieved reference embeddings; display an alert to the user interface (110) in real-time, when the new product is validated or invalidated; a payment validation module (116) operably coupled to the processing unit (116). The payment validation module (116) is configured to validate a total weight of scanned products in the smart shopping cart (102) against cumulative weight of all products placed inside the smart shopping cart (102) measured by the at least one load cell (108); block payment when a discrepancy is detected.

Another aspect of the present invention provides that the smart shopping cart (102) comprises a basket (102a) arranged at the top of the load cell (108) for receiving items thereinto; a charging transmitter (102b) arranged at front of the basket (102a) for transmitting power to a second smart shopping cart; a charging receiver (102c) arranged at back of the basket (102a) for receiving power from a power supply or a first smart shopping cart; a user interface case (102d) integrated at top of the basket (102a) for fitting the user interface (110) thereto; a power bank (102e) provided with the user interface case (102d) for charging the user interface (110); and a computer device (102f) configured to store memory for executing a plurality of instructions processed by the processing unit (114).

Another aspect of the present invention provides that the vector database is configured to store a plurality of reference embeddings, each reference embedding comprises data related to the following: a plurality of reference product images; a plurality of weight data for each product; and a plurality of barcode data for cross-referencing during validation.

Another aspect of the present invention provides that the processing unit (114) performs the multimodal similarity search by computing a multimodal similarity score using at least one of the following: a similarity of the extracted image embeddings with the plurality of reference embeddings; the measured weight of the at least one product using the at least one load cell (108) with retrieved reference weight; and the scanned barcode with the retrieved barcode data.

Another aspect of the present invention provides that the processing unit (114) queries the vector database using extracted image embedding, to perform a multimodal similarity search, thereby retrieving matching reference embeddings and reference data associated therewith, further wherein the processing unit is configured to apply a majority voting mechanism across top results retrieved from the vector database to determine most likely match for the new product.

Another aspect of the present invention provides that the AI model is trained on a dataset of the plurality of reference product images to learn visual characteristics of each product, the plurality of reference product images are captured using a data collection machine, DCM, that ensures high-resolution and 360° view of the products, wherein the AI model is configured to enable the processing unit (114) to extract and generate the image embeddings from the foreground image of the new product, wherein the image embeddings are compact vector representations of the product images, and capture unique features of each product.

Another aspect of the present invention provides that the processing unit (114) tags the new product to be valid when the extracted image embeddings and data related to the scanned bar code matches with the retrieved reference embeddings tags, the new product is deemed valid when the multimodal similarity score of matching exceeds a predefined threshold.

Another aspect of the present invention provides that the user interface (110) is further configured to display real-time alerts related to valid and/or invalid products; show cumulative weight of products added to the smart shopping cart (102); and provide a detailed summary of all validated and invalidated products.

Another aspect of the present invention provides that the processing unit (114) blocks payment when discrepancy is detected, further wherein the discrepancy is selected from a group comprising at least one of the following: the cumulative weight exceeds the total weight by a predefined margin of error; any unscanned products are detected in the smart shopping cart (102); or the multimodal similarity score of the extracted image embeddings falls below the predefined threshold.

A further aspect of the present invention provides that the at least one camera (106) is configured to provide high-resolution images of the interior of the smart shopping cart (102) from at least three predefined angles for improved product identification accuracy.

Additional aspect of the present invention provides a method (300) for smart shopping in a retail environment, the method (300) comprising steps of scanning a barcode of a product using a barcode scanner before placing the product in a smart shopping cart (302); capturing a background image of interior of the smart shopping cart using at least one camera prior to placing a new product therein (304); capturing a foreground image of the interior of the smart shopping cart after placing the new product inside the smart shopping cart (306); processing the background image and the foreground image to identify and isolate the new product (308); extracting an image embedding of the new product from the foreground image using an Artificial Intelligence, AI model (310); querying a vector database using the extracted image embedding to retrieve reference embeddings, reference weight data, and barcode data for validation (312); comparing the extracted image embedding and scanned barcode with retrieved reference embeddings to compute a multimodal similarity score (314); validating the new product when the extracted image embeddings and data related to the scanned bar code matches with the retrieved reference embeddings (316); displaying an alert to the user interface when the new product is validated or invalidated in real-time (318); and validating a total weight of scanned products in the smart shopping cart against cumulative weight of all products placed inside the smart shopping cart, measured by the load cells (320); and block payment when a discrepancy is detected (322).

Yet another aspect of the present invention provides that the querying a vector database using the extracted image embedding to retrieve reference embeddings, reference weight data, and barcode data for validation (312), further comprises applying a majority voting mechanism across top results retrieved from the vector database to determine most likely match for the new product.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1a illustrates a block diagram of a system (100) for smart shopping in a retail environment, in accordance with an embodiment of the present invention;

FIG. 1b illustrates a schematic illustration of a smart shopping cart (102), in accordance with an embodiment of the present invention;

FIG. 2a and FIG. 2b illustrate the exemplary instances (200a) and (200b), respectively, where the foreground image and the background image captured by the camera are separated, and image of new product is thereby isolated, in accordance with an embodiment of the present invention;

FIG. 2c illustrates a process of processing product images using a data collection machine for training the AI model, in accordance with an embodiment of the present invention;

FIG. 3 illustrates a method (300) for smart shopping in a retail environment, in accordance with an embodiment of the present invention;

FIG. 4 illustrates a block diagram depicting a network environment, in accordance with an embodiment of the present invention;

FIG. 4a illustrates a block diagram of modules stored in memory, in accordance with an embodiment of the present invention;

FIG. 4b illustrates a schematic diagram of exemplary shopping list options for the customer, in accordance with an embodiment of the present invention;

FIG. 4c illustrates a schematic diagram of exemplary weekend shopping list created by the customer, in accordance with an embodiment of the present invention;

FIG. 5 illustrates a schematic diagram of exemplary price list for the shopping list created by a customer, in accordance with an embodiment of the present invention;

FIG. 6 illustrates a schematic diagram of exemplary real time aggregated hyper local demand provided to retailers, in accordance with an embodiment of the present invention;

FIG. 7 illustrates a schematic diagram of login by the customer on the exemplary smart shopping cart inside offline shopping store, in accordance with an embodiment of the present invention;

FIG. 8 illustrates a schematic diagram of exemplary shopping list retrieved by a customer from the shopping system, in accordance with an embodiment of the present invention;

FIG. 9 illustrates a schematic diagram of payment process on the exemplary smart shopping cart, in accordance with an embodiment of the present invention; and

FIG. 10 illustrates an exemplary flowchart illustrating a method for facilitating shopping from offline retailers, in accordance with an embodiment of the present invention.

To facilitate understanding, like reference numerals have been used, where possible, to designate like elements common to the figures.

### DETAILED DESCRIPTION

The present invention relates to system and method for smart shopping in a retail environment. In particular, the present invention provides a system and method for smart shopping that utilizes a processing unit integrated with a smart shopping cart, for analysing data derived from product images, scanned barcodes, and associated weight measurements, for detecting any unscanned product placed inside the smart shopping cart.

As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed.

However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The system (100) for automated product validation, identification and prevention of any unscanned item placed inside the cart, and transaction management integrates a plurality of processes and methods to achieve highly accurate and efficient results. The system begins with the capturing of product images through at least one camera, which is configured to capture high-resolution images from predefined angles to ensure coverage of the interior of the smart shopping cart. Each product's images are processed using an AI model trained on a dataset of reference product images captured by a data collection machine (DCM), which ensures a high-resolution, 360° view of each product for robust training. The AI model extracts image embeddings, which are unique vectorized representations of the product's features, including shape, color, texture, and other distinguishing visual characteristics. These embeddings are stored in a vector database alongside reference data, such as barcode information and product weight.

When new products are added to the smart shopping cart, the system employs a multimodal similarity search to validate each product by comparing its extracted image embeddings, and scanned barcode information against the reference data or embeddings stored in the vector database. A similarity score is computed for validation, where the system uses advanced algorithms, including algorithm for majority voting across top database results, to identify the most likely match. The user interface provides real-time feedback, displaying cumulative weight, validated product lists, and alerts for invalid products. If discrepancies are detected—such as unscanned products, mismatches between expected and measured weight, or low similarity scores—the system immediately flags the issue. Additionally, the processing unit is configured to block payment until the discrepancies are resolved, ensuring security and accuracy. This comprehensive validation process eliminates the risk of errors that could arise from solely relying on conventional barcode scanning or manual product verification methods.

The technical effect achieved by this invention surpasses conventional shopping systems by introducing a multimodal product validation approach, addressing challenges such as incomplete or inaccurate product verification. Conventional systems, which typically rely only on barcode scanning, fail to detect unscanned products, mismatches in product weight, or fraud due to errors in product recognition. By using the combination of high-resolution multi-angle imaging, advanced AI model-based image processing, and integrated multimodal data validation, the present invention ensures accurate product identification even under complex conditions, such as when products are misaligned, obscured, or without a visible barcode. Additionally, the automated processing of multiple data streams, including real-time weight measurement and image-based validation, significantly enhances operational efficiency by removing manual intervention.

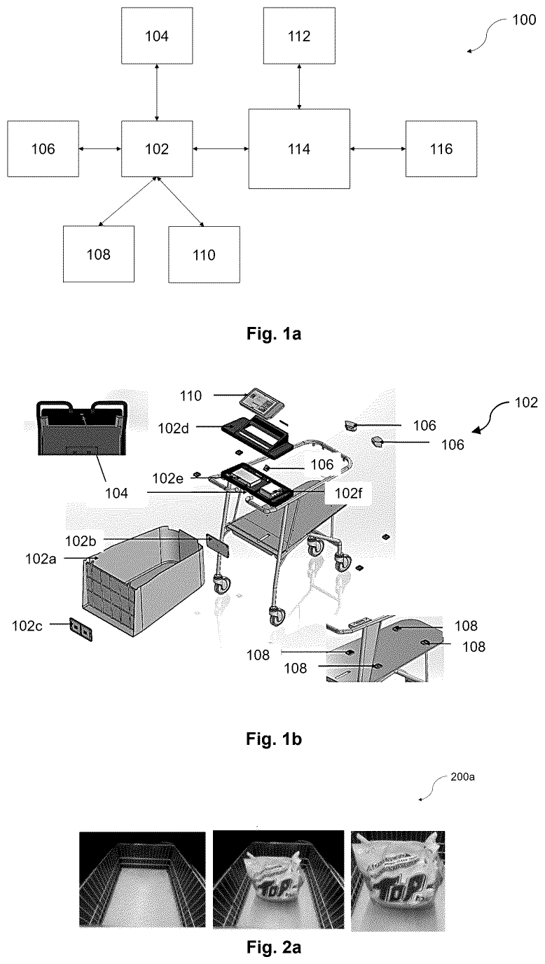

Reference is made to FIG. 1a, where there is illustrated a system (100) for smart shopping in a retail environment, in accordance with an embodiment of the present invention.

The system (100) incorporates several technical components and mechanisms that collectively ensure accurate validation and monitoring of products added to a smart shopping cart (102) by a customer. The system (100) is particularly advantageous for preventing fraudulent activities such as bypassing product scanning or substituting scanned items with unscanned ones. The system (100) comprises a smart shopping cart (102) configured to collect and hold at least one product. The smart shopping cart (102) serves as a platform for various integrated components that enable the detection and validation of products during a shopping session.

A barcode scanner (104) is provided as part of the system (100) to allow customers to scan the barcode of each product before placing it inside the smart shopping cart (102). The barcode scanner (104) captures product-identifying information, such as product type, weight, and price, and transmits this data to a processing unit (114) for further validation. The scanning step ensures that every product intended to be added to the smart shopping cart (102) is recorded in the system (100).

The system (100) further comprises at least one camera (106) positioned strategically at predefined locations on or within the smart shopping cart (102). The at least one camera (106) is configured to capture images of the interior of the smart shopping cart (102). Specifically, the at least one camera (106) performs two distinct image of capturing a background image of the interior of the smart shopping cart (102) before the addition of a new product, and capturing a foreground image of the interior of the smart shopping cart (102) after the addition of the new product.

These captured images are transmitted to the processing unit (114) for analysis, wherein the background and foreground images are processed to identify and isolate the newly added product. This process involves image differencing techniques to detect the changes between the two images. In an embodiment, the at least one camera (106) integrated within the system (100) is configured to capture high-resolution images of the interior of the smart shopping cart (102) from at least three predefined angles. These angles are strategically selected to enhance the visibility and coverage of the smart shopping cart's interior, ensuring that all products placed inside are accurately identified. By providing multiple high-resolution perspectives, the cameras (106) improve the accuracy of product identification by the AI model, which processes the captured images to extract image embeddings. The multi-angle approach reduces blind spots and enhances the system's capability to identify products irrespective of their orientation or position within the cart.

The system (100) includes at least one load cell (108) integrated with the smart shopping cart (102). The load cell (108) is configured to measure the weight of each product added to the smart shopping cart (102). The measured weight data is transmitted to the processing unit (114) and is used for validating whether the product's actual weight matches the expected weight retrieved from the database arrangement (112). The integration of the load cell (108) allows for precise detection of discrepancies in product weight, which could indicate potential shoplifting or scanning errors.

A user interface (110) is also integrated with the smart shopping cart (102). The user interface (110) provides real-time feedback to the customer, displaying a list of products successfully added to the smart shopping cart (102). Additionally, the user interface (110) generates alerts to notify the customer when a product is either successfully validated or invalidated due to discrepancies.

In an embodiment, the user interface (110) is specifically configured to provide real-time updates and alerts to the user. The user interface (110) is configured to display real-time alerts pertaining to the validation status of products, whether valid or invalid, based on the comparison of the scanned barcode, image embeddings, and weight data. Additionally, the user interface (110) is configured to show the cumulative weight of all products added to the smart shopping cart (102) as measured by the load cell (108), providing users with a clear and instantaneous summary of their shopping activity. Further, the user interface (110) is capable of presenting a detailed summary of all products, distinguishing between those that have been validated successfully and those that have been flagged as invalid, enabling enhanced transparency and user control during the shopping process.

The system (100) further comprises a database arrangement (112) that includes a vector database. The vector database stores a plurality of reference embeddings associated with various products. Each reference embedding in the vector database includes data such as visual embeddings derived from product images, weight information, and barcode data. This comprehensive dataset serves as the basis for validating new products added to the smart shopping cart (102).

A processing unit (114) is communicably coupled to the barcode scanner (104), the at least one camera (106), the load cell (108), and the database arrangement (112). The processing unit (114) is responsible for managing and analyzing data from these components. Optionally, the processing unit (114) is coupled to the database arrangement (112) via a data communication network.

Upon receiving scanned barcode data from the barcode scanner (104), the processing unit (114) processes the background and foreground images captured by the at least one camera (106) to identify and isolate the newly added product.

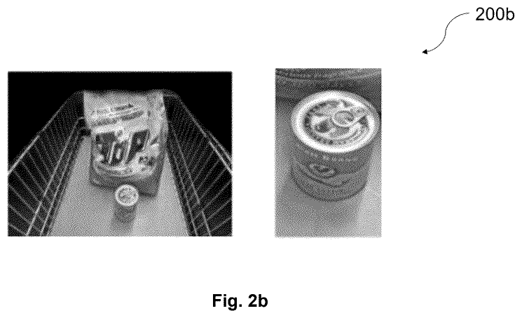

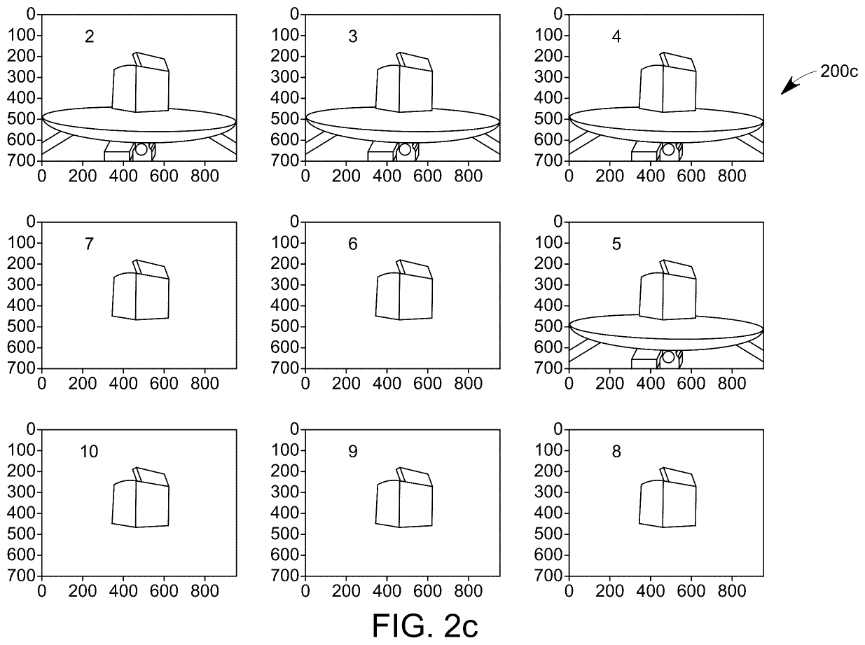

In describing further on FIG. 1a, reference is made to FIG. 2a, and FIG. 2b, where there is illustrated exemplary instances where the image of newly added product is isolated by comparing and separating the background and the foreground images. As described above, the camera captured the background image before placing the new product, and the foreground image after placing the new product. Thereafter, the processing unit isolates the image of the new product using an Artificial Intelligence (AI) based machine learning model, hereafter referred to as AI model.

The processing unit (114) then extracts image embeddings of the newly added product using the Artificial Intelligence (AI) model trained on a dataset of reference product images. These image embeddings represent unique features of the product, such as shape, size, and color.

The extracted image embedding is thereafter used to query the vector database, initiating a multimodal similarity search. The multimodal similarity search retrieves matching reference embeddings and associated data, including weight and barcode information. The processing unit (114) compares the extracted image embedding of the new product and the scanned barcode against the retrieved reference embeddings to ensure accuracy. If the extracted embedding and scanned barcode match the retrieved reference embeddings and associated data, the processing unit (114) tags the new product as valid. Otherwise, the product is invalidated, and an alert is generated on the user interface (110). Optionally, the alert is sent to the admin of the retail store as well, for notifying thereof about potential unscanned items either deliberately or inadvertently.

The system (100) also includes a payment validation module (116) operably coupled to the processing unit (114). The payment validation module (116) performs a final check by validating the total weight of scanned products in the smart shopping cart (102) against the cumulative weight of all products placed in the cart, as measured by the load cell (108). If discrepancies in weight or unscanned items are detected during this validation step, the payment validation module (116) blocks payment and notifies the customer via the user interface (110).

In an embodiment, the discrepancies are identified from a group comprising, but not limited to, the following conditions: the cumulative weight of products measured by the load cell (108) exceeds the total weight of scanned products by a predefined margin of error, indicating potential misalignment or unscanned products; the detection of any unscanned products in the smart shopping cart (102), based on the comparison of image embeddings and reference data; or when the multimodal similarity score, generated by comparing the extracted image embeddings of a new product with reference embeddings, falls below a predefined threshold. The system (100), specifically the payment validation module (116) working in conjunction with the processing unit (114), ensures that discrepancies are flagged immediately, and payment is restricted until the issue is resolved, thereby preventing unauthorized or incorrect transactions.

This system (100) ensures comprehensive product validation by combining data from multiple sources, including barcode scans, image embeddings, and weight measurements. It provides an efficient and accurate solution for preventing any unscanned items to be placed inside the cart, enhancing the security of self-checkout processes, and improving the overall customer experience in a retail environment.

In describing further on FIG. 1, reference is made to FIG. 1b, where there is illustrated a schematic illustration of a smart shopping cart (102), in accordance with an embodiment of the present invention.

The smart shopping cart (102) comprises multiple components integrated to facilitate the functionality of the system (100) for detecting any unscanned items placed inside the cart, and enabling efficient operation in a retail environment. Each component of the smart shopping cart (102) is strategically configured and positioned to support the overall functionality of the system (100).

The smart shopping cart (102) includes a basket (102a), arranged at the top of the load cell (108). The basket (102a) is configured to receive and hold items placed therein by a customer during a shopping session. The basket (102a) serves as the primary container for the products being validated and monitored by the system (100). Its arrangement atop the load cell (108) ensures accurate weight measurement of the items added to the smart shopping cart (102).

At the front of the basket (102a), a charging transmitter (102b) is provided. The charging transmitter (102b) is configured to transmit power to an adjacent smart shopping cart in situations where multiple smart shopping carts (102) are used in a connected arrangement. This configuration facilitates efficient power sharing and enables the operation of multiple carts in scenarios such as bulk shopping or group shopping environments.

At the back of the basket (102a), a charging receiver (102c) is positioned. The charging receiver (102c) is designed to receive power from an external power supply or a first smart shopping cart in a connected chain. This arrangement ensures that the smart shopping cart (102) can maintain continuous operation by utilizing power from either a primary source or another cart.

The top of the basket (102a) is integrated with a user interface case (102d). The user interface case (102d) is configured to securely house the user interface (110). The placement of the user interface (110) in the user interface case (102d) allows easy access for the customer, enabling real-time display of product validation results, alerts, and other relevant information during the shopping session.

A power bank (102e) is provided within the user interface case (102d). The power bank (102e) is configured to charge the user interface (110), ensuring uninterrupted operation of the system (100) even in cases where the primary power supply is unavailable. The integration of the power bank (102e) within the user interface case (102d) enhances portability and convenience by eliminating the need for external charging mechanisms for the user interface (110).

Additionally, the smart shopping cart (102) includes a computer device (102f). The computer device (102f) is configured to store memory for storing a plurality of instructions executed by the processing unit (114). The memory also includes the trained AI model that provides instructions to the processing unit for detecting unscanned items. The computer device (102f) plays a critical role in enabling the system (100) to perform data-intensive operations, including processing captured images, extracting embeddings, querying the vector database, and managing multimodal similarity searches. Its integration within the smart shopping cart (102) ensures that the system (100) operates efficiently in a real-time operation.

The detailed integration of the basket (102a), charging transmitter (102b), charging receiver (102c), user interface case (102d), power bank (102e), and computer device (102f) within the smart shopping cart (102) ensures that the system (100) is self-sufficient, highly functional, and capable of operating seamlessly in a retail environment.

In an embodiment, the system (100) includes a vector database as part of the database arrangement (112). The term “vector database” refers to a specialized database designed to store and query high-dimensional vectors, such as image embeddings, using similarity metrics like cosine similarity or Euclidean distance. This configuration ensures that the system (100) can retrieve the most relevant reference data for validating the newly added product.

The vector database is configured to store a plurality of reference embeddings, wherein each reference embedding comprises data related to multiple characteristics of a product. These characteristics include a plurality of reference product images, which are high-resolution visual representations of the product captured from different angles, ensuring a comprehensive dataset for product recognition.

Additionally, the vector database stores a plurality of weight data, which corresponds to the expected weight of each product. The weight data is associated with each product's unique identifier to facilitate comparison with the actual weight measured by the load cell (108). Furthermore, the vector database stores a plurality of barcode data that uniquely identifies each product and allows for cross-referencing during validation. By integrating these diverse types of data, the vector database enables accurate and efficient product validation during a shopping session.

In an embodiment, the processing unit (114) performs a multimodal similarity search by computing a multimodal similarity score using at least one of three distinct parameters which are similarity of image embeddings, weight data comparison, and barcode data validation.

In an instance related to similarity of image embeddings, the processing unit (114) compares the extracted image embeddings of the newly added product, derived from the foreground image, with the plurality of reference embeddings stored in the vector database. Optionally, this similarity is quantified using a metric, such as cosine similarity, which measures how closely the extracted embeddings match the reference embeddings.

In an instance related to weight data comparison, the processing unit (114) compares the measured weight of the newly added product, obtained from the load cell (108), with the reference weight data retrieved from the vector database. Optionally, the processing unit is configured in a manner such that a predefined margin of error, such as ±3%, is allowed to account for minor discrepancies in weight.

In an instance related to barcode validation, the processing unit (114) cross-references the scanned barcode data with the retrieved barcode data from the vector database. This ensures that the barcode of the newly added product matches the stored reference data for the identified product.

As described above, the processing unit computes a multimodal similarity score combining aforementioned parameters, either individually or in a weighted manner, to ensure robust validation. This multimodal approach reduces false positives and enhances the accuracy of product identification.

In an embodiment, the processing unit (114) queries the vector database using the extracted image embeddings to perform a multimodal similarity search. The vector database returns a ranked list of matching reference embeddings, each associated with a similarity score. To determine the most likely match for the newly added product, the processing unit (114) applies a majority voting mechanism.

In an instance, the majority voting mechanism evaluates the top results retrieved from the vector database. Each result is assigned a weight based on its similarity score, and the result with the highest cumulative weight is selected as the most likely match. This approach ensures that the system (100) considers multiple potential matches while prioritizing the most accurate identification. By employing majority voting, the system (100) achieves a higher level of confidence in product validation, particularly when the newly added product has visual similarities to multiple reference products.

In an embodiment, the processing unit (114) tags the newly added product as valid when the extracted image embeddings and the scanned barcode data match the retrieved reference embeddings and associated data from the vector database. The system (100) deems the product valid if the multimodal similarity score exceeds a predefined threshold.

In an example, the predefined threshold is a numerical value that serves as a benchmark for validating a product. In a specific example for a particular product, a similarity score exceeding 0.9 (on a scale of 0 to 1) may indicate a high confidence match. If the similarity score falls below the threshold, the product is tagged as invalid, and an alert is generated. This alert is displayed on the user interface (110) in real-time, notifying the customer and potentially escalating the issue to store personnel.

By implementing a threshold-based validation system, the processing unit (114) ensures that only accurately identified products are deemed valid.

In an embodiment, the AI model is utilized by the processing unit for separating the foreground and the background images of a particular product placed inside the smart shopping cart (102).

The AI model utilized by the processing unit (114) is trained on a dataset comprising a plurality of reference product images. These reference product images are captured using a specialized apparatus known as a data collection machine, DCM. The DCM ensures high-resolution image capture and generates a 360° view of each product by rotating the product through predefined angles, such as, for example, 15° increments. This process yields a comprehensive dataset of images that represent each product from multiple perspectives.

The AI model is configured to process these images and learn the visual characteristics of each product, such as shape, texture, color, and size. Using this trained dataset, the AI model generates image embeddings for the products. An image embedding is a compact vector representation that encodes the unique features of a product image into a mathematical form, enabling efficient comparison and similarity calculations.

The processing unit (114) utilizes the trained AI model to extract image embeddings from the foreground image of the newly added product. These embeddings are then used to query the vector database and perform the multimodal similarity search. By leveraging high-quality training data and advanced AI techniques, the system (100) ensures accurate and reliable product identification.

In describing further on FIG. 1a, reference is made to FIG. 2c where there is illustrated a process utilized for training the AI model using diverse product images captured under specific conditions and subsequently processed to separate the foreground from the background, in accordance with an embodiment of the present invention. The depicted process demonstrates how raw images of a product are systematically converted into high-quality, usable representations through a series of steps.

Initially, at step 1, a raw image of the product is captured using the data collection machine (DCM). The DCM ensures high-resolution images are obtained, capturing all significant details of the product under controlled lighting and orientation. Subsequently, the captured image undergoes white balancing, at Step 2, wherein color corrections are applied to normalize the lighting conditions and eliminate any color casts, ensuring consistent quality across all product images.

Following this, the background white normalization, at step 3, removes unnecessary color variations in the background, converting it to a uniform white tone. This normalization enhances the clarity of the product features and creates a neutral background for further processing. In the subsequent background extraction, at step 4, phase, the system isolates the product from the background by detecting and removing the areas irrelevant to the product's shape and form.

Once the background is removed, the foreground contrast adjustment, at step 5, is applied to enhance the visibility of intricate details of the product. This step ensures that critical features, such as product labeling, texture, and shape, are prominently represented in the processed image. The Foreground Extraction, at step 6, identifies the precise boundaries of the product, defining the area of interest that is to be retained for subsequent use.

Further processing includes image cropping, at step 8, and image correction, at step 9, which refine the product image by eliminating residual artifacts and adjusting the dimensions to conform to predefined standards. Lastly, the processed image undergoes a background conversion to white, at step 10, ensuring that the final image saved in the library is devoid of extraneous elements and ready for use in AI model training.

The postproduction process detailed above is critical to ensuring the quality and usability of the images fed into the AI model. The processed images are then used to train the AI model to extract and recognize unique visual features of the products, facilitating robust and accurate multimodal similarity searches. By incorporating a high volume of images, including multiple angles and variations, the AI model learns to generate compact vector representations of the products, known as image embeddings, which form the basis for the product identification and validation mechanism described in the system.

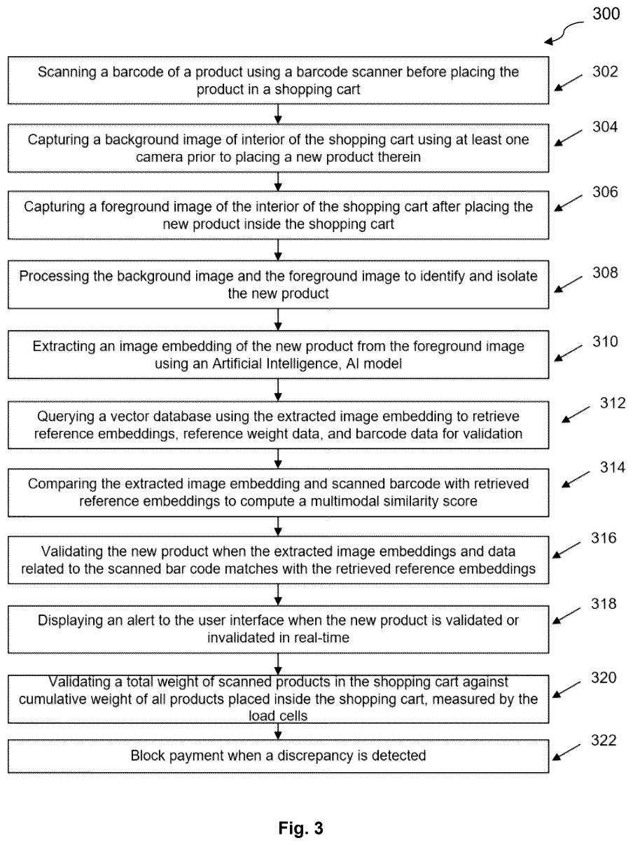

Reference is made to FIG. 3 where there is illustrated a method (300) smart shopping in a retail environment, in accordance with an embodiment of the present invention.

The method (300) initiates at step (302) that comprises scanning a barcode of a product using a barcode scanner before placing the product in a smart shopping cart. Further, the method (300) comprises capturing a background image of interior of the smart shopping cart using at least one camera prior to placing a new product therein, at step (304), and capturing a foreground image of the interior of the smart shopping cart after placing the new product inside the smart shopping cart, at step (306). Furthermore, the method (300) comprises processing the background image and the foreground image to identify and isolate the new product, at step (308), and extracting an image embedding of the new product from the foreground image using an Artificial Intelligence, AI model, at step (310). Thereafter, the method (300) comprises querying a vector database using the extracted image embedding to retrieve reference embeddings, reference weight data, and barcode data for validation, at step (312). At step (314), the method (300) comprises comparing the extracted image embedding and scanned barcode with retrieved reference embeddings to compute a multimodal similarity score. Further, at step (316), the method (300) comprises validating the new product when the extracted image embeddings and data related to the scanned bar code matches with the retrieved reference embeddings, and displaying an alert to the user interface when the new product is validated or invalidated in real-time, at step (318). Subsequently, the method (300) comprises validating a total weight of scanned products in the smart shopping cart against cumulative weight of all products placed inside the smart shopping cart, measured by the load cells, at step (320), and thereafter, blocking payment when a discrepancy is detected (322).

In an embodiment, the method of querying a vector database using the extracted image embedding to retrieve reference embeddings, reference weight data, and barcode data for validation (312), further comprises applying a majority voting mechanism across top results retrieved from the vector database to determine most likely match for the new product.

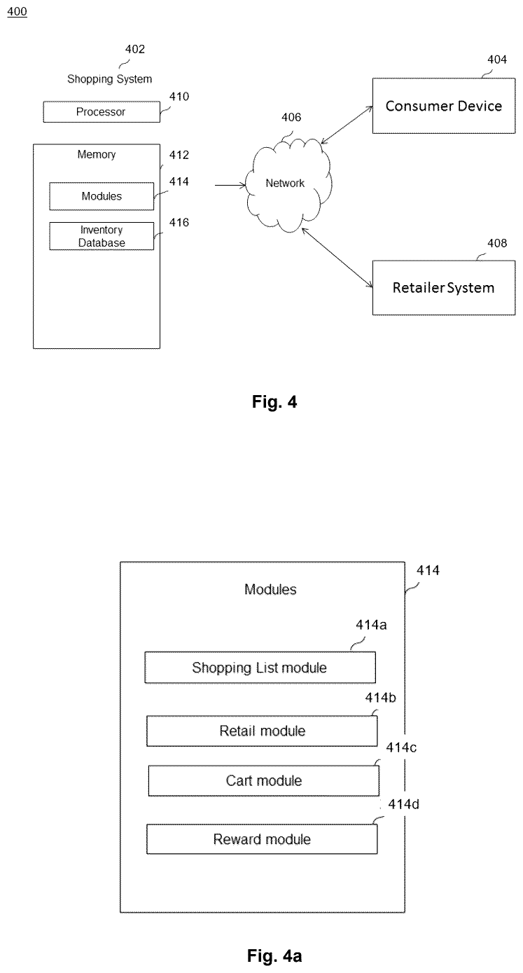

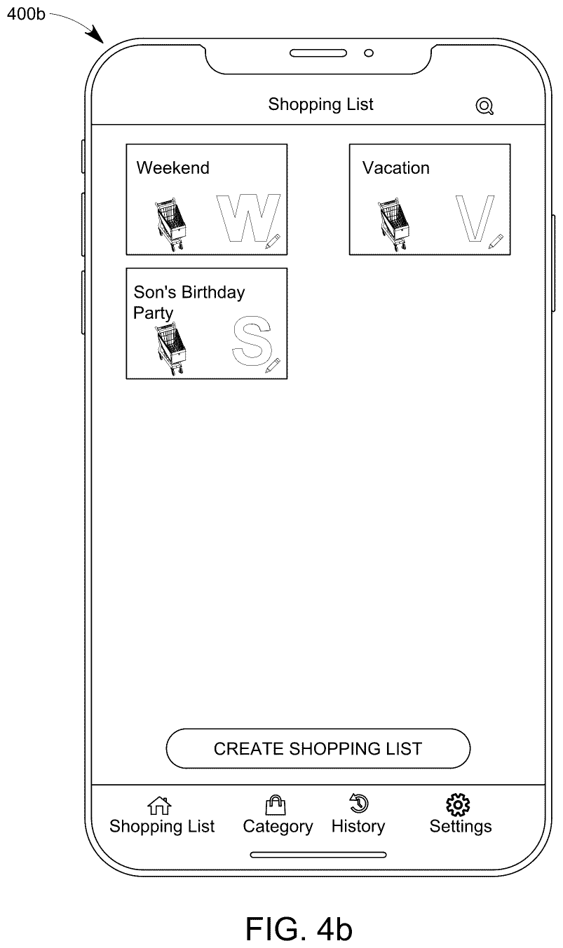

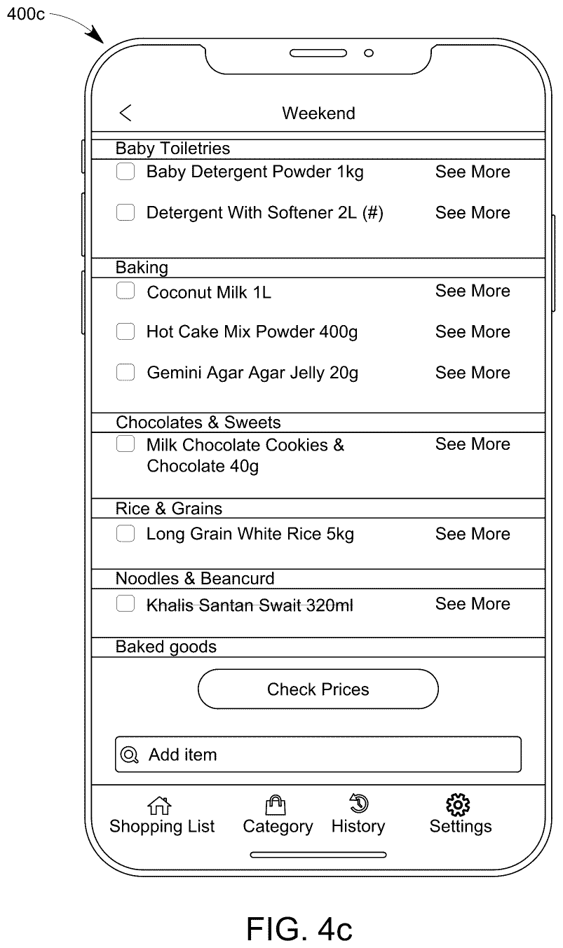

Reference is made to FIG. 4, where there is illustrated an exemplary network environment (400). The network environment (400) includes a shopping module (402) connected to various consumer devices (404) and various retailer systems (408) via a network (406). In an embodiment, the retailers (408) are offline retailers or brick and mortar retailers. Further, the consumers (404) are shoppers who wish to purchase various items of their need from these retailers (408). The Network (406) may include, but is not restricted to, a communication network such as Internet, PSTN, Local Area Network (LAN), Wide Area Network (WAN), Metropolitan Area Network (MAN), and so forth. In an embodiment, the network (406) can be a data network such as the Internet. Further, the messages exchanged between the shopping system (402) and the consumers devices (404) can comprise any suitable message format and protocol capable of communicating the information necessary for the shopping system (402) to create a shopping list having items currently desired by the customers and provide the shopping list to the retailer systems (408). The retailers may utilize the shopping list to get insights into customers real time demand and may offer promotions on the items in demand to increase their sales.

In an embodiment of the present invention, the shopping module (402) may be a computing device. In an instance, the shopping module (402) is the user's personal smart phone. In operation, a user of the consumer device (404) may access the shopping module (402) to provide his/her shopping preferences or shopping items that he intends to buy in near future. The shopping module (402) includes a processor (40410) and a memory (412). In one embodiment, the processor (40410) includes a single processor and resides at the shopping module (402). In another embodiment, the processor (40410) may include multiple sub-processors and may reside at the shopping system as well as the retailer system (408) and consumer device (404).

Further, the memory (412) includes one or more instructions that may be executed by the processor (40410) to enable a plurality of customers to create their shopping list, to share the shopping list with a plurality of retailers, and to enable the plurality of customers to book a cart with the plurality of retailers. In one embodiment, the memory (412) includes the modules (414), an inventory database (416), and other data (not shown in figure). The other data may include various data generated during processing the shopping list of customers. In one embodiment, the database (416) is stored internal to the shopping module (402). In another embodiment, the database (416) may be stored external to the shopping module (402), and may be accessed via the network (406). Furthermore, the memory (412) of the shopping module (402) is coupled to the processor (40410).

Referring to FIG. 4a, the modules (414) includes a shopping list module (414a), a retail module (414b), a cart module (414c), and a reward module (414d). The modules (414) are instructions stored in the memory and may process shopping list to provide enhanced shopping experience for the consumers and retailers.

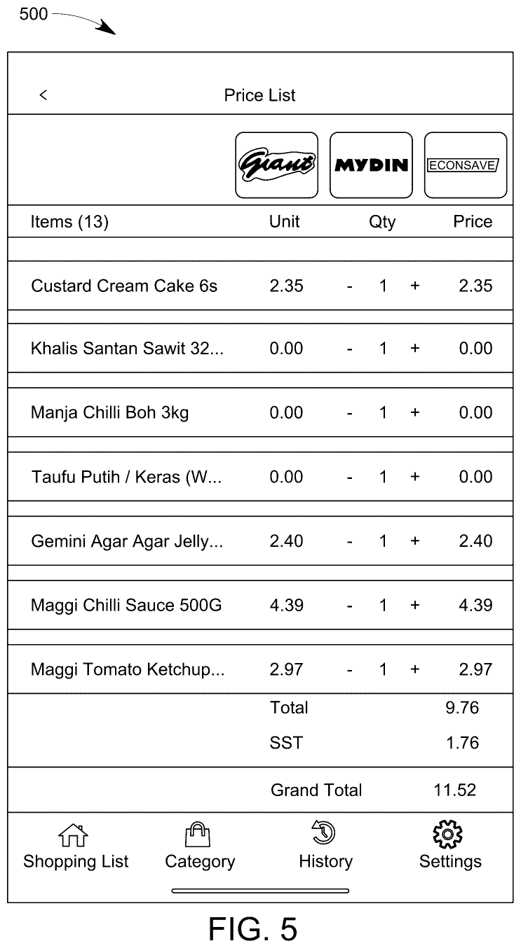

According to an embodiment of the present invention, the shopping list module (414a) is configured to enable a plurality of customers to create their shopping list. In an embodiment, the shopping list may be for weekend, vacation, and birthday party, as shown in FIG. 4b. In an embodiment, the shopping list module (414a) is configured to enable customers to search an item of their choice, and add the item to their shopping list. In an embodiment, the customers may search item based on product type, product, and brand. For example, the customer may search ‘Jack Daniel’ whisky item. Similarly, the shopping list module (414a) is configured to enable the customer to create a shopping list of his/her weekly grocery items, as shown in FIG. 4c. Further, the shopping list module (414a) is configured to enable the customers to check prices of each item in the shopping list and whole shopping list, as shown in FIG. 5.

Further, the shopping list module (414a) is configured to enable the plurality of customers to provide his/her shopping preferences and home inventory. The customer may create multiple shopping lists as well, for example, for their weekend, party, vacation or kids. The shopping list module (414a) is configured to enable the customers to search an item and add items from a consolidated list of goods/products from participating merchants/retailers to one or more of their shopping lists. The shopping list module (414a) is configured to enable the customers to search and add recipes or write one into favorite's recipes and share them.

In case, the item is available in the inventory database (416), the shopping list module (414a) is configured to find the item, and enable the customer to add the item to his/her shopping list. Further, the shopping list module (414a) is configured to display the available items of customer choice on a dashboard. In an embodiment, the shopping list module (414a) is further configured to enable the plurality of customers to check prices of items in the shopping list according to different retailers on the dashboard, as shown in FIG. 5.

Further, the shopping list module (414a) is configured to enable consumers to compare real-time prices of items in their list across multiple retailers, track existing stock at home or office and expiry dates of items. Those skilled in the art will appreciate that the shopping list may provide real time information to the customers/consumers/shoppers about availability of items with different retailers with prices to assist them to plan purchase of the list as per their budget. For example, the customer is able to check dynamic pricing of items in the shopping list and may book the product whenever he gets best offer.

The shopping list module (414a) is further configured to share their shopping list with their family members and friends. The shopping list module (414a) is further configured to enable the family members and friends to edit the shopping list. For example, it is possible that the family members and friends may want to add an item of their choice or edit an item in the shopping list according to their choice or experience. The shopping list module (414a) is further configured to enable the shoppers to update the shopping list themselves.

Further, according to an embodiment of the present invention, the shopping list module (414a) is configured to enable consumers to keep track of unused stock of products at home/pantry/larder, based on purchased items by the users in shopping history. In an embodiment, the shopping list module (414a) may utilize artificial intelligence such as machine learning to keep track of unused stock of products at the consumer's home/pantry/larder. For example, if the consumer ordered a product before 1 month, and is again looking for same product without using/finishing earlier product, the shopping list module (414a) may remind the consumer that this product was also ordered during last month. Those skilled in the art will appreciate that it will facilitate reduction in wastage of products.

Further, the shopping list module (414a) is configured to enable the consumers to keep track of expiry date of stock of products at home/pantry/larder. In one embodiment, the shopping list module (414a) is configured to utilize the inventory data provided by retailers to keep track of the expiry date of the products. In another embodiment, the shopping list module (414a) enables the consumers to manually add such information about the products. For example, if the consumer ordered a product before some months, and the consumer has not used the product, while the product may be approaching its expiry date soon. The shopping list module (414a) may remind the consumer that this product was ordered on last month and is fast approaching its expiry date, so that the user may consume it as soon as possible. Those skilled in the art will appreciate that it will facilitate reduction in wastage of products.

Further, according to an embodiment of the present invention, the shopping list module (414a) is configured to suggest to consumers various items or recipes, based on unused stock in pantry/larder when connected with retailer or partner recipe portals. For example, if the consumer ordered a packet of breads during last purchase without butter jam or Nutella, the shopping list module (414a) may suggest the consumer to order the jam or Nutella from a retailer's store. Those skilled in the art will appreciate that it will facilitate reduction in wastage of products and enhance the user experience by providing value to the customer.

Further, according to an embodiment of the present invention, the shopping list module (414a) is configured to keep a track of consumer's likes/choice and preference about preferred products and a preferred brand of products. Further, the shopping list module (414a) is configured to keep a track of user dislikes of products from products list that the consumer usually drops or no longer purchase from their usual lists. The shopping list module (414a) is configured to store the user's choices in the database and utilize the choices to profile the user. Based upon the profile, the shopping list module (414a) may suggest suitable products from nearby retailers (based upon mobile location) as and when they are available or available at lower price. Those skilled in the art will appreciate that such profiling of users would enable higher degree of personalization for each user and better services for the user.

In an embodiment, the shopping list module (414a) is further configured to enable the retailers to register themselves with the shopping system and to integrate their inventory records or database with the inventory database (416). The shopping list module (414a) is further configured to enable the retailers to list services provided by them for customers. Further, the shopping list module (414a) is configured to display items required by the customers on the dashboard. Those skilled in the art will appreciate that the retailers have access to real time demand of the customers to manage their stock keeping units in the inventory and offer various promotions to increase their sales.

The retail module (414b) is configured to aggregate the shopping lists of the plurality of customers, and share the aggregated shopping list with a plurality of retailers, manufacturers, and fast moving consumer goods company (FMCG). The retail module (414b) is further configured to tag geographic location of the plurality of customers and provide to the plurality of retailers, manufacturers and companies. Those skilled in the art will appreciate that such geographical tagging will help retailers and manufacturers to assess demand of different items/products from different locations/regions.

Further, the retail module (414b) is configured to aggregate local demand of customers for a geographic location, and further to provide the aggregated local demands to the nearby offline stores for same geographic locations, based upon mobile locations of the customers. Those skilled in the art will appreciate that such geographical tagging will help retailers and manufacturers to assess demand of different items/products from nearby locations and manage their inventory as per local demand.

The retail module (414b) is configured to enable the retailers to upload their inventory (for example, using API), to the inventory database (416). The retail module (414b) is further configured to map the shopping list to databases of the plurality of retailers and inform the retailers about their inventory status, based on the shopping list. For example, it is possible that inventory of a retailer for a particular item that is in a lot of demand, may be empty or will soon become empty. The retail module (414b) may further map the shopping list to retailer stock keeping unit (SKU) databases and may create a single database of SKUs from all participating merchants automatically. The retail module (414b) may also remove duplicates and correct errors, while retaining individual merchant SKU databases.

Further, according to an embodiment of the present invention, the retail module (414b) is configured to utilize artificial intelligence such as machine learning to predict items demanded by customers in future, so as to assist the retailers in managing their inventory. For example, some items may be demanded by customers at particular times and the machine learning may determine such patterns to advice retailers to manage their inventory in warehouses. Further, the retail module (414c) is configured to utilize artificial intelligence to suggest suitable pricing to the retailers that the customers are likely to go ahead. In an embodiment, based on such demand of customers, the retailers may launch various marketing campaigns to customers via email or SMS.

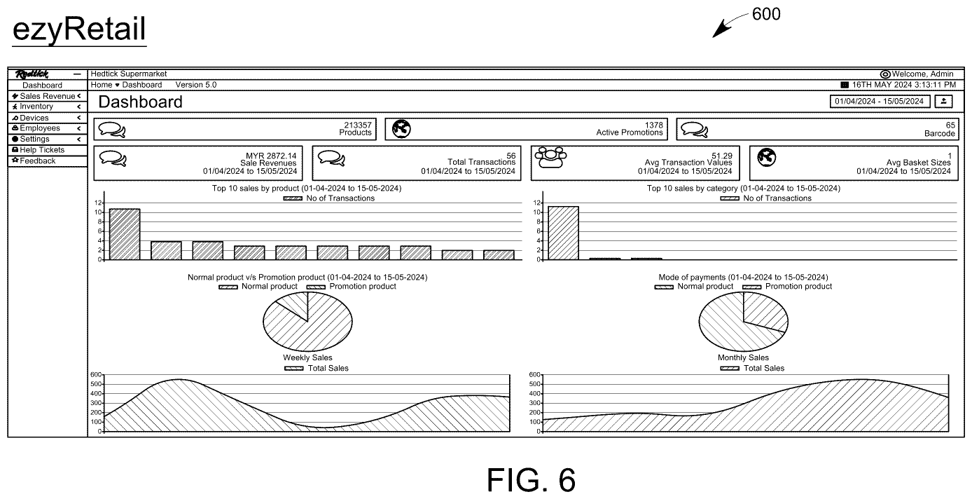

The retail module (414b) is configured to enable the retailers to access aggregated shopping list data. In an embodiment, the retailers may access the shopping lists via dashboards of aggregated shopping list data, as shown in FIG. 6. The retail module (414b) is configured to provide an interface between the retailers and customers that allows retailers to engage customers inside the store or outside the store. The retail module (414b) is configured to provide demographic details of the customers to the retailers. In an embodiment, the demographic details may be used by the retailers to provide suitable promotional offers to the customers. For example, a particular section of the populations (like adults and old people) are more likely to use fitness products, thus the retailers may tailor their promotions accordingly so as to offer discounts to such customers and increase sales and revenue.

The retail module (414b) is further configured to enable the plurality of retailers and manufacturers to provide a dynamic price and promotions for items in the shopping list. Those skilled in the art will appreciate that different retailers may have tie-up with different brands or manufacturers, and may provide promotions and discount on items accordingly. For example, a particular retailer may provide discount on beverage items, while another retailer may provide discount on electronic items. For example, a particular retailer may offer ‘3’ products in price of ‘2’ products. Further, the retailer may club a group of different type of products in a bundle, and offer them at a discounted price.

Similarly, a particular retailer may provide discount (for example, 20%) on butter products, while another retailer may provide discounts on cooking oil products. Further, different retailers and manufacturers may offer discounts on particular days like Christmas. In an embodiment, the retail module (414b) is configured to display promotions (such as promotions this week in the store) on a display of home page of the portal. Those skilled in the art will appreciate that such promotions enables the retailers to engage the customers and increase their sales.

In an embodiment, the cart module (414c) is configured to enable the plurality of customers to choose a retailer based upon the pricing, and book a smart shopping cart (102) with the retailer. The customer may add items of the shopping list to the smart shopping cart (102) of the chosen retailer and book the cart. In another embodiment, the cart module (414c) is configured to enable the customers to make payment for the shopping list as well. Further, in an embodiment, the cart module (414c) may provide list of items of the shopping list to the retailer (such as offline retailer) to keep ready those items of the cart whenever customer visits the store.

Further, the cart module (414c) is configured to enable the retailers to identify such shoppers when they enter the store, and personalize prices, promotions and messages based on their profile. When customer visits the store, the retailer may direct the customer to a payment gateway that may provide different payment options to the customer like Internet banking, Credit card, debit card or digital wallet (in case payment has not been done). The retailers may provide enhanced shopping experience to such customers like these customers may pay and checkout in-cart without queuing.

The reward module (414d) is configured to enable the retailers to provide rewards to the plurality of customers based upon the payment by the customer. In an embodiment, based on offers of a particular retailer, the reward module (414d) may provide reward points based on volume of purchase done by customer, and may add reward points in an account of the customer. The reward points may be exchanged for items or cash as reward by the customers.

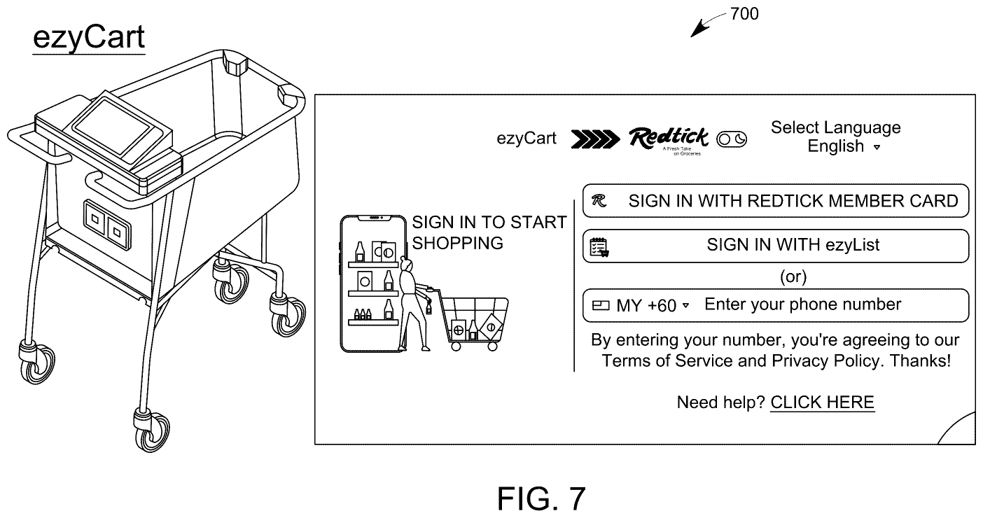

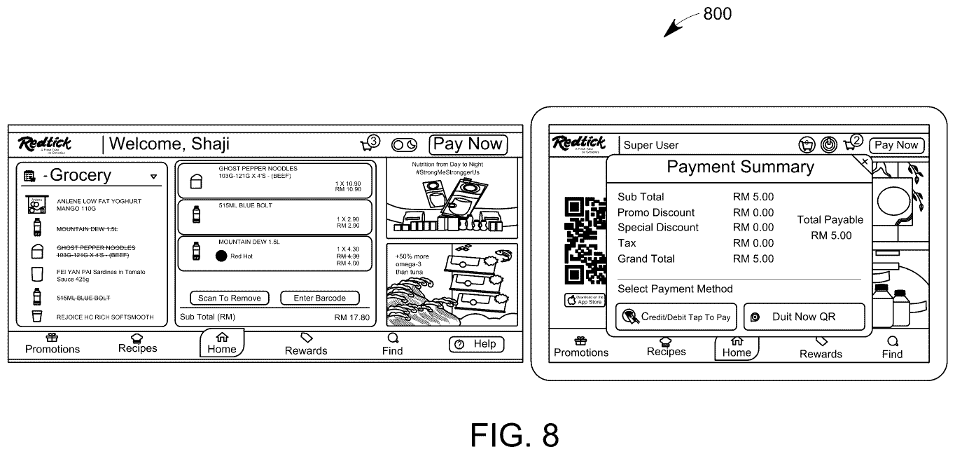

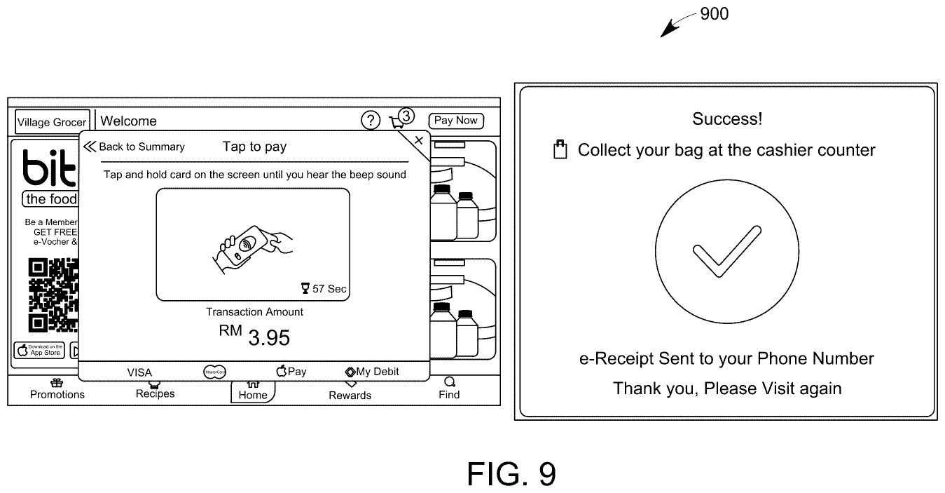

According to an embodiment of the present invention, the customer may choose to visit the offline store based upon dynamic promotions and pricing offered by the retailers. The customer may access the smart shopping cart (102) inside the offline store and may complete login process first, as shown in FIG. 7. In case of successful login, the customer may retrieve his/her shopping list (as shown in FIG. 8), that he/she created earlier using the shopping list module (414a), and may add desired items of the shopping list in the smart shopping cart by scanning them with the bar code scanner.

In a particular embodiment, in case the customer add any item inadvertently or deliberately without scanning the item first, the camera provided at the smart shopping cart may still capture the product image and send the product image to the back end system of the store that may check/verify whether the customer scanned the product before inserting in the smart shopping cart. In case, the customer missed scanning of any product, the backend system may display a notification to the customer to scan the product first. Those skilled in the art will appreciate that such cross-checking or counter-checking by the backend system may help avoiding a potential fraud by any customer.

After adding all items of shopping list inside the smart shopping cart (102), the customer is enabled to make the payment on the smart shopping cart itself, as shown in FIG. 9. The customer may choose a payment method, make the payment, and may perform self-checkout without joining any queue.

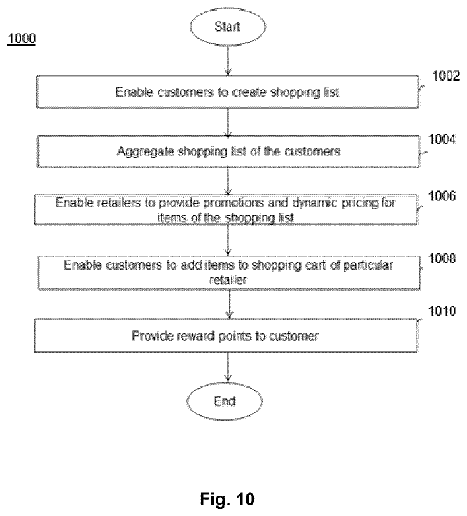

FIG. 10 illustrates an exemplary flowchart of a shopping method for facilitating shopping of customers from various retailers, according to an embodiment of the present invention. Initially, at step 1002, customers are enabled to create their shopping lists. In an embodiment, customers are enabled to search item based on product type, product, and brand. The customer may create multiple shopping lists as well, for example, for their party, vacation or kids.

At step 1004, the shopping lists of the plurality of customers are aggregated. Further, the aggregated shopping list is shared with a plurality of retailers, manufacturers, and fast moving consumer goods company (FMCG). Further, local demand of customers for a geographic location may be aggregated, and the aggregated local demands may be provided to the nearby offline stores for same geographic locations, based upon mobile locations of the customers. Those skilled in the art will appreciate that such geographical tagging will help retailers and manufacturers to assess demand of different items/products from nearby locations and manage their inventory as per local demand. Further, the shopping list may be mapped to databases of the plurality of retailers and inform the retailers about their inventory status, based on the shopping list. In an embodiment, artificial intelligence may be used to predict items demanded by customers in future, so as to assist the retailers in managing their inventory. At step 1006, retailers are enabled to provide a dynamic pricing and promotions for items in the shopping list. For example, various retailers may be having specialization in sales of particular items, like a particular retailer may provide discount on beverage items, while another retailer may provide discount on electronic items. Further, different retailers and manufacturers may offer discounts on different days of year. Further, dynamic prices and promotions (such as promotions this week in the store) may be displayed on a display of home page of the system. Further, a total price offered by the plurality of retailers may be compared for the shopping list, and the comparison may be provided to the plurality of customers to help them make a decision about choice of store to purchase items in the shopping list.

At step 1008, the customers are enabled to add items of the shopping list to a cart. In an embodiment, the customers are able to see dynamic pricing of items in their shopping lists and may choose to buy the items in the shopping lists when prices offered by retailers meets their budget. When customer visits the store, the retailers may identify such shoppers based on their profiles on shopping system, and these customers may pay and checkout with cart without queuing.

At step 1010, reward points to the plurality of customers are provided from the plurality of retailers, based upon the payment. For example, based on volume of purchase done by customer, reward points may be added in an account of the customer. The reward points may be exchanged for items or cash as reward by the customers.

The shopping module (402) and the method (1000) performed by the shopping system (402) advantageously provides enhanced shopping experience of customers with traditional brick and mortar shopping stores. For example, the shopping module (402) advantageously enables customers to check dynamic pricing of items in the shopping list and may book the product whenever he gets best offer. Further, the shopping module (402) advantageously assists the retailers in managing their inventory. Further, the shopping module (402) advantageously provides precise demand to offline retailers about who, what, and when of shopping requirements of customers. The retailers may use such insights to offer the consumer's dynamic demand-based prices and promotions.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for smart shopping in a retail environment, comprising:
a smart shopping cart for collecting at least one product therein;
a barcode scanner, for enabling a customer to scan barcode of the at least one product, before placing inside the smart shopping cart;
at least one camera, positioned at predefined positions of the smart shopping cart, for capturing images of interior thereof, the at least one camera is configured to:
capture a background image of the interior of the smart shopping cart before a new product is placed, and
capture a foreground image of the interior of the smart shopping cart after the new product is placed;
at least one load cell, integrated within the smart shopping cart, configured to measure weight of the at least one product added to the smart shopping cart;
a user interface integrated with the smart shopping cart for displaying a list of products added to the smart shopping cart in real-time;
a database arrangement comprising a vector database, for storing a plurality of reference embeddings related to the at least one product;
a processing unit, communicably coupled to the database arrangement, the barcode scanner, the at least one camera, and the load cell, wherein the processing unit is configured to:
receive scanned barcode data from the barcode scanner;
process the background image and the foreground image captured by the at least one camera to identify and isolate the new product;
extract image embeddings of the new product using an Artificial Intelligence, AI model trained on reference product images;
query the vector database using extracted image embedding, to perform a multimodal similarity search, thereby retrieving matching reference embeddings and reference data associated therewith;
compare the extracted image embeddings of the new product and the scanned barcode against the retrieved reference embeddings;
tag the new product to be valid when the extracted image embeddings and data related to the scanned bar code matches with the retrieved reference embeddings;
display an alert to the user interface in real-time, when the new product is validated or invalidated;
a payment validation module operably coupled to the processing unit, configured to:
validate a total weight of scanned products in the smart shopping cart against cumulative weight of all products placed inside the smart shopping cart measured by the at least one load cell; and
block payment when a discrepancy is detected.

2. The system according to claim 1, wherein the smart shopping cart comprises:
a basket arranged at the top of the load cell for receiving items thereinto;
a charging transmitter arranged at front of the basket for transmitting power to a second smart shopping cart;
a charging receiver arranged at back of the basket for receiving power from a power supply or a first smart shopping cart;
a user interface case integrated at top of the basket for fitting the user interface thereto;
a power bank provided with the user interface case for charging the user interface; and
a computer device comprising a memory for storing a plurality of instructions and the AI model, executed by the processing unit.

3. The system according to claim 1, wherein the vector database is configured to store a plurality of reference embeddings, each reference embedding comprises data related to:
a plurality of reference product images;
a plurality of weight data for each product, and
a plurality of barcode data for cross-referencing during validation.

4. The system according to claim 1, wherein the processing unit performs the multimodal similarity search by computing a multimodal similarity score using at least one of:
a similarity of the extracted image embeddings with the plurality of reference embeddings;
the measured weight of the at least one product using the at least one load cell with retrieved reference weight; and
the scanned barcode with the retrieved barcode data.

5. The system according to claim 1, wherein the processing unit queries the vector database using extracted image embedding, to perform a multimodal similarity search, thereby retrieving matching reference embeddings and reference data associated therewith, further wherein the processing unit is configured to:
apply a majority voting mechanism across top results retrieved from the vector database to determine most likely match for the new product.

6. The system according to claim 1, wherein the AI model is trained on a dataset of the plurality of reference product images to learn visual characteristics of each product, the plurality of reference product images are captured using a data collection machine, DCM, that ensures high-resolution and 360° view of the products, wherein the AI model is configured to:
enable the processing unit to extract and generate the image embeddings from the foreground image of the new product, wherein the image embeddings are compact vector representations of the product images, and capture unique features of each product.

7. The system according to claim 1, wherein the processing unit tags the new product to be valid when the extracted image embeddings and data related to the scanned bar code matches with the retrieved reference embeddings tags, the new product is deemed valid when the multimodal similarity score of matching exceeds a predefined threshold.

8. The system according to claim 1, wherein the user interface is further configured to:
display real-time alerts related to valid and/or invalid products;
show cumulative weight of products added to the smart shopping cart; and
provide a detailed summary of all validated and invalidated products.

9. The system according to claim 1, wherein the processing unit blocks payment when discrepancy is detected, further wherein the discrepancy is selected from a group comprising at least one of:
the cumulative weight exceeds the total weight by a predefined margin of error;
any unscanned products are detected in the smart shopping cart; or
the multimodal similarity score of the extracted image embeddings falls below the predefined threshold.

10. The system according to claim 1, wherein the at least one camera is configured to provide high-resolution images of the interior of the smart shopping cart from at least three predefined angles for improved product identification accuracy.

11. A method for smart shopping in a retail environment, the method comprising steps of:
scanning a barcode of a product using a barcode scanner before placing the product in a smart shopping cart;
capturing a background image of interior of the smart shopping cart using at least one camera prior to placing a new product therein;
capturing a foreground image of the interior of the smart shopping cart after placing the new product inside the smart shopping cart;
processing the background image and the foreground image to identify and isolate the new product;
extracting an image embedding of the new product from the foreground image using an Artificial Intelligence, AI model;
querying a vector database using the extracted image embedding to retrieve reference embeddings, reference weight data, and barcode data for validation;
comparing the extracted image embedding and scanned barcode with retrieved reference embeddings to compute a multimodal similarity score;
validating the new product when the extracted image embeddings and data related to the scanned bar code matches with the retrieved reference embeddings;
displaying an alert to the user interface when the new product is validated or invalidated in real-time; and
validating a total weight of scanned products in the smart shopping cart against cumulative weight of all products placed inside the smart shopping cart, measured by the load cells; and
blocking payment when a discrepancy is detected.

12. The method according to claim 11, wherein querying a vector database using the extracted image embedding to retrieve reference embeddings, reference weight data, and barcode data for validation, further comprises applying a majority voting mechanism across top results retrieved from the vector database to determine most likely match for the new product.
